(19) United States
(12) Patent Application Publication
(10) Pub. No.: US 2025/0200345 A1
(43) Pub. Date: Jun. 19, 2025

(54) NEURAL NETWORK HAVING ACCURACY-LATENCY BALANCE

(71) Applicants: International Business Machines Corporation, Armonk, NY (US); ECOLE POLYTECHNIQUE FEDERALE DE LAUSANNE (EPFL), Lausanne (CH)

(72) Inventors: Ana Stanojevic, Zurich (CH); Giovanni Cherubini, Rueschlikon (CH); Angeliki Pantazi, Thalwil (CH); Stanislaw Andrzej Wozniak, Kilchberg (CH); Guillaume Bellec, Ecublens (CH); Wulfram Gerstner, Ecublens (CH)

(21) Appl. No.: 18/539,328

(22) Filed: Dec. 14, 2023

(51) Int. Cl. G06N 3/049; G06N 3/0985

(52) U.S. Cl. CPC G06N 3/049; G06N 3/0985

(57) ABSTRACT

A computer-implemented method includes executing a spiking neural network (SNN) to perform an SNN task. The SNN includes accuracy-latency balance (ALB) characteristics that enable the SNN to perform the SNN task in a manner that achieves a predetermined ALB of an output generated by the SNN.

### BACKGROUND

The present invention relates in general to programmable computers that implement neural networks. More specifically, the present invention relates to computer-implemented methods, computing systems, and computer program products that train and execute neural networks.

### SUMMARY

Embodiments of the invention are directed to a computer-implemented method that includes using a processor system to perform processor system operations. The processor system operations include executing a spiking neural network (SNN) to perform a SNN task. The SNN includes accuracy-latency balance (ALB) characteristics that enable the SNN to perform the SNN task in a manner that achieves a predetermined ALB of an output generated by the SNN.

Embodiments of the invention are also directed to computer systems and computer program products having substantially the same features and functionality as the computer-implemented method described above.

Additional features and benefits are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and benefits of the embodiments are apparent from the following detailed description taken in conjunction with the accompanying drawings in which:

FIG. 1 depicts an exemplary computing environment operable to implement aspects of the invention;

FIG. 2 depicts a simplified sketch of a biological neuron, which is modeled by computer systems in accordance with aspects of the invention;

FIG. 3A depicts a simplified block diagram illustrating a model of a biological neuron operable to be utilized in neural network architectures in accordance with aspects of the invention;

FIG. 3B depicts a simplified block diagram illustrating a deep learning neural network architecture in accordance with aspects of the invention;

FIG. 4A depicts a simplified block diagram illustrating a spiking neural network (SNN) architecture operable to be utilized in implementing aspects of the invention;

FIG. 4B depicts a simplified block diagram illustrating a single-spike SNN (SS-SNN) architecture operable to be utilized in implementing aspects of the invention;

FIG. 4C depicts a graph illustrating an example of a spiking neuron's membrane potential behavior during a spike in accordance with aspects of the invention;

FIG. 4D depicts plots illustrating the concept of regularization loss utilized in accordance with aspects of the invention;

FIG. 5A depicts a simplified block diagram illustrating novel accuracy-latency balance (ALB) in accordance with aspects of the invention;

FIG. 5B depicts a simplified block diagram illustrating an SNN during tuning of the SNN's prediction model to include ALB in accordance with aspects of the invention;

FIG. 5C depicts a simplified block diagram illustrating an SNN post-tuning of the SNN's prediction model to include ALB in accordance with aspects of the invention;

FIG. 6 depicts a simplified block diagram illustrating an SNN during training of the SNN's prediction model to include ALB in accordance with aspects of the invention;

FIG. 7 depicts a simplified block diagram illustrating an SNN during model conversion or model mapping operations to form the SNN's mapped prediction model to include ALB in accordance with aspects of the invention;

FIG. 8 depicts a flow diagram illustrating a tuning methodology in accordance with aspects of the invention;

FIG. 9 depicts equations operable to implement ALB training operations in accordance with aspects of the invention;

FIG. 10 depicts a diagram illustrating how aspects of ALB training operations can be implemented in accordance with aspects of the invention;

FIG. 11 depicts equations operable to implement ALB training operations in accordance with aspects of the invention;

FIG. 12 depicts a graph illustrating performance results for an SNN with eight hundred (800) hidden neurons and ALB in accordance with aspects of the invention;

FIG. 13 depicts a table illustrating performance results for an SNN with ALB in accordance with aspects of the invention;

FIG. 14 depicts a graph and a block diagram that illustrate aspects of ALB with neural network mapping (NN-mapping) in accordance with aspects of the invention;

FIG. 15 depicts equations operable to implement ALB with NN-mapping in accordance with aspects of the invention;

FIG. 16 depicts equations operable to implement ALB with NN-mapping in accordance with aspects of the invention; and

FIG. 17 depicts a graph illustrating performance results for an SNN with ALB in accordance with aspects of the invention.

In the accompanying figures and following detailed description of the disclosed embodiments, the various elements illustrated in the figures are provided with three-digit reference numbers. In some instances, the leftmost digits of each reference number correspond to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The various components/modules of the systems illustrated herein are depicted separately for ease of illustration and explanation. In embodiments of the invention, the functions performed by the various components/modules can be distributed differently than shown without departing from the scope of the various embodiments of the invention describe herein unless it is specifically stated otherwise.

Although this detailed description includes references to modeling biological neural networks with a specific emphasis on modeling brain structures and functions, implementation of the teachings recited herein are not limited to modeling any particular environment. Rather, embodiments of the invention are capable of being implemented in conjunction with any other type of environment, for example, weather patterns, arbitrary data collected from the internet, etcetera, as long as the various inputs to the environment can be turned into a vector.

Although this detailed description describes various aspects of computer system architectures, for ease of reference and explanation some features and/or functionality of the disclosed computer system architecture are described using neurological terminology such as neurons, synapses, spikes, and the like. It will be understood that for any discussion or illustration herein of a computer system architecture, the use of neurological terminology or neurological shorthand notations are for ease of reference and are meant to cover the neural network equivalents of the described neurological function and/or neurological component.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

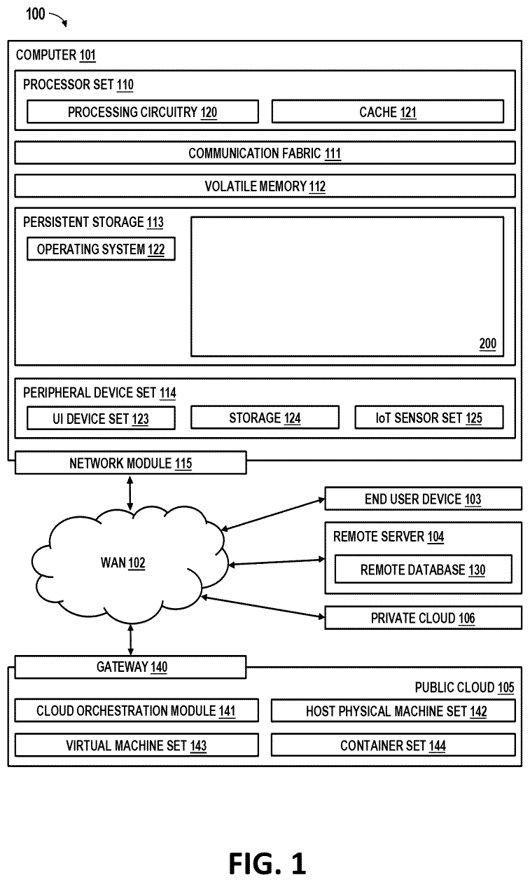

FIG. 1 depicts a computing environment 100 that contains an example of an environment for the execution of at least some of the computer code involved in performing the inventive methods, such as code block 200 operable to train and execute neural networks that perform novel accuracy-latency balance operations. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In its simplest form, artificial intelligence (AI) is a field that combines computer science and large-scale, comprehensive datasets to enable problem-solving. In general, AI refers to the broad category of machines that can mimic human cognitive skills. AI also encompasses the sub-fields of machine learning and deep learning. AI systems can be implemented as AI algorithms that perform as cognitive systems that make predictions or classifications based on input data.

A category of machines that can mimic human cognitive skills is neural networks (NNs). In general, a NN is a network of artificial neurons or nodes inspired by the biological neural networks of the human brain. The artificial neurons/nodes of a NN are organized in layers and typically include input layers, hidden layers and output layers. Neuromorphic and synaptronic systems, which are also referred to as artificial neural networks (ANNs), are computational systems that permit electronic systems to essentially function in a manner analogous to that of biological brains. Neuromorphic and synaptronic systems do not generally utilize the traditional digital model of manipulating zeros (0s) and ones (1s). Instead, neuromorphic and synaptronic systems create connections between processing elements that are roughly functionally equivalent to neurons of a biological brain. Neuromorphic and synaptronic systems can be implemented using various electronic circuits that are modeled on biological neurons.

Spiking neural networks (SNNs) are ANNs that more closely mimic natural or biological neural networks. In addition to neuronal and synaptic state, SNNs incorporate the concept of time into their operating model. Neurons in an SNN transmit information only when a membrane potential, which is an intrinsic quality of the neuron related to its membrane electrical charge, reaches a specific value called the threshold. When the membrane potential reaches the threshold, the neuron fires, thereby generating a signal that travels to other downstream neurons. The transmitted signal increases or decreases the downstream neuron's membrane potential. A neuron model that fires at the moment of threshold crossing is also called a spiking neuron model. Similar to other NNs, the neurons of an SNN are organized into layers that include an input layer, an output layer and one or more hidden layers between the input layer and the output layer.

So-called single-spike SNNs (SS-SNNs) are configured and arranged such that each neuron of each layer spikes at most once. Limiting the number of spikes limits the computational and communication demands at each neuron, which generally improves the computational efficiency of SS-SNNs in comparison to other NNs such as conventional ANNs.

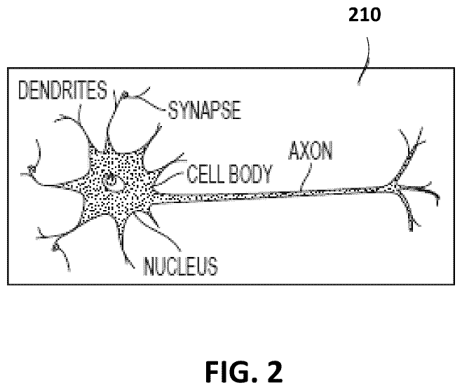

As context for embodiments of the invention described herein, an overview of biological neural networks will now be provided. FIG. 2 depicts a sketch of a biological neuron 210. The biological neuron 210, also known as a nerve cell, is a special biological cell that processes information. As shown, it is composed of a cell body, or soma, and two types of outward reaching, tree-like branches, namely, the axon and the dendrites. The cell body has a nucleus that contains information about hereditary traits and a cytosol that holds the molecular equipment for producing material needed by the neuron. A neuron receives signals (impulses) from other neurons through its dendrites (receivers) and transmits signals generated by its cell body along the axon (transmitter), which eventually branches into strands and sub-strands. At the terminals of these strands are the synapses. A synapse is an elementary structure and functional unit between two neurons (an axon strand of one neuron and a dendrite of another). When the impulse reaches the synapse's terminal, certain chemicals called neurotransmitters are released. The neurotransmitters diffuse across the synaptic gap, to enhance or inhibit, depending on the type of the synapse, the receptor neuron's own tendency to emit electrical impulses. The synapse's efficacy can be adjusted by the signals passing through it so that synapses can learn from the histories of activities in which they participate. This dependence on history acts as a memory, which is possibly responsible for human memory.

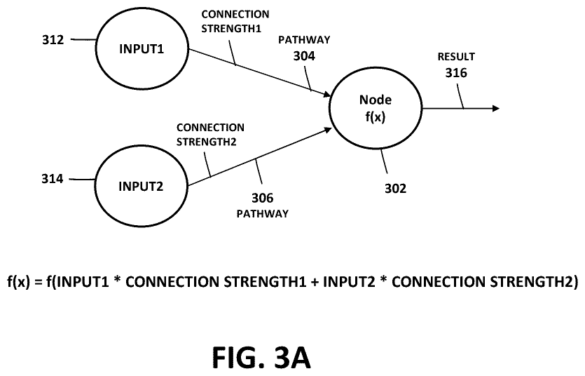

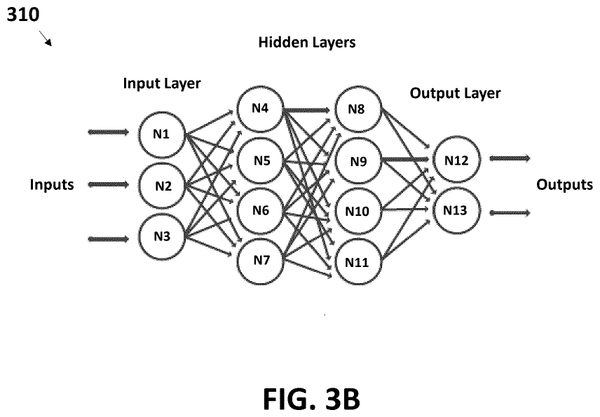

In FIG. 3A, the biological neuron 210 (shown in FIG. 2) is modeled as a node 302 having a mathematical function, f(x), depicted by the equation shown in FIG. 3A. Node 302 receives electrical signals from inputs 312, 314, multiplies each input 312, 314 by the strength of its respective connection pathway 304, 306, takes a sum of the inputs, passes the sum through a function, f(x), and generates a result 316, which may be a final output or an input to another node, or both. In this detailed description, an asterisk (*) is used to represent a multiplication. Under some circumstances, weak input signals are multiplied by a very small connection strength number, so the impact of a weak input signal on the function is very low. Similarly, under some circumstances, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

FIG. 3B depicts a simplified example of a neural network architecture (or model) 310. In some embodiments of the invention, the neural network architecture/model 310 can be a deep learning neural network architecture/model. In general, neural networks can be implemented as a set of algorithms running on a programmable computer (e.g., computing environment 100 shown in FIG. 1). In some instances, neural networks are implemented on an electronic neuromorphic machine (e.g., a computer chip) that attempts to create connections between processing elements that are substantially the functional equivalent of the synapse connections between brain neurons. In either implementation, neural networks incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical). The basic function of a neural network is to recognize patterns by interpreting sensory data through a kind of machine perception. Real-world data in its native form (e.g., images, sound, text, or time series data) is converted to a numerical form (e.g., a vector having magnitude and direction) that can be understood and manipulated by a computer. The neural network is “trained” by performing multiple iterations of learning-based analysis on the real-world data vectors until patterns (or relationships) contained in the real-world data vectors are uncovered and learned.

Neural networks use feature extraction techniques to reduce the number of resources required to describe a large set of data. The analysis on complex data can increase in difficulty as the number of variables involved increases. Analyzing a large number of variables generally requires a large amount of memory and computation power. Additionally, having a large number of variables can also cause a classification algorithm to over-fit to training samples and generalize poorly to new samples. Feature extraction is a general term for methods of constructing combinations of the variables in order to work around these problems while still describing the data with sufficient accuracy.

Although the patterns uncovered/learned by a neural network can be used to perform a variety of tasks, two of the more common tasks are labeling (or classification) of real-world data and determining the similarity between segments of real-world data. Classification tasks often depend on the use of labeled datasets to train the neural network to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, the like. Similarity tasks apply similarity techniques and (optionally) confidence levels (CLs) to determine a numerical representation of the similarity between a pair of items.

Referring again to FIG. 3B, the neural network architecture/model 310 is organized as a weighted directed graph, wherein the artificial neurons are nodes (e.g., N1-N13), and wherein weighted directed edges (i.e., directional arrows) connect the nodes. The neural network architecture/model 310 is organized such that nodes N1, N2, N3 are input layer nodes, nodes N4, N5, N6, N7 are first hidden layer nodes, nodes N8, N9, N10, N11 are second hidden layer nodes, and nodes N12, N13 are output layer nodes. The use of multiple hidden layers indicates that the neural network architecture/model 310 is a deep learning neural network architecture/model. Each node is connected to every node in the adjacent layer by connection pathways, which are depicted in FIG. 3B as directional arrows each having its own connection strength. For ease of illustration and explanation, one input layer, two hidden layers, and one output layer are shown in FIG. 3B. However, in practice, multiple input layers, multiple hidden layers, and multiple output layers can be provided.

Each input layer node N1, N2, N3 of the neural network architecture/model 310 receives Inputs directly from a source (not shown) with no connection strength adjustments and no node summations. Each of the input layer nodes N1, N2, N3 applies its own internal f(x). Each of the first hidden layer nodes N4, N5, N6, N7 receives its inputs from all input layer nodes N1, N2, N3 according to the connection strengths associated with the relevant connection pathways. Thus, in first hidden layer node N4, its function is a weighted sum of the functions applied at input layer nodes N1, N2, N3, where the weight is the connection strength of the associated pathway into the first hidden layer node N4. A similar connection strength multiplication and node summation is performed for the remaining first hidden layer nodes N5, N6, N7, the second hidden layer nodes N8, N9, N10, N11, and the output layer nodes N12, N13.

The neural network architecture/model 310 (or ANN 310) can be implemented to include various connection patterns or architectures. Based on the connection pattern, ANNs can be grouped into two general categories, namely, feed-forward networks in which graphs have no loops, and feed-back or recurrent networks in which loops occur because of feed-back connections. In the most common family of feed-forward networks, known generally as multilayer perceptron networks, neurons are organized into layers that have unidirectional connections between them.

Different connectivity in ANNs yields different network behaviors. In general, feed-forward networks are static. In other words, they produce only one set of output values rather than a sequence of values from a given input. Feed-forward network dynamics are memory-less in the sense that their response to an input is independent of the previous network state (though their weights may hold history-dependent state). By contrast, feed-back or recurrent networks are dynamic systems. When a new input pattern is presented, the neuron outputs are computed. Because of the feed-back paths, the signals can travel in both directions using loops. All possible connections between neurons are allowed. Because loops are present in this type of network, under certain operations, it can become a non-linear dynamical system that changes continuously until it reaches a state of equilibrium. Feed-back networks are often used in associative memories and optimization problems where the network looks for the best arrangement of interconnected factors.

The neural network architecture/model 310 (or ANN 310) can implement various deep learning-based feature extraction and classification methods. In general, deep learning-based classification schemes have two sub-networks, a feature extraction network followed by a classification sub-network, and the two networks are learned jointly during training. Different network architectures require appropriate learning algorithms. The ability to learn is a fundamental trait of intelligence. A learning process in the ANN context can be viewed as the problem of updating network architecture and connection weights so that a network can efficiently perform a specific task. The network usually must learn the connection weights from available training patterns. Performance is improved over time by iteratively updating the weights in the network. An ANN's ability to automatically learn from examples makes it an attractive design option. Instead of following a set of rules specified by human experts, ANNs appear to learn underlying rules (like input-output relationships) from the given collection of representative examples. This is one of the major benefits of ANNs over traditional expert systems.

In order to understand or design a learning process, it is necessary to have a model of the environment in which a neural network operates. In other words, the information that is available to the network must be known. This model may be referred to as a learning paradigm. Additionally, it must be understood how network weights are updated. In other words, the learning rules that govern the updating process must be understood. A learning algorithm refers to a procedure in which learning rules are used for adjusting the weights. There are three main learning paradigms: supervised, unsupervised, and hybrid. In supervised learning, or learning with a “teacher,” the network is provided with a correct answer (output) for every input pattern. Weights are determined to allow the network to produce answers as close as possible to the known correct answers. Reinforcement learning is a variant of supervised learning in which the network is provided with only a critique on the correctness of network outputs, not the correct answers themselves. In contrast, unsupervised learning, or learning without a teacher, does not require a correct answer associated with each input pattern in the training data set. It explores the underlying structure in the data, or correlations between patterns in the data, and organizes patterns into categories from these correlations. Hybrid learning combines supervised and unsupervised learning. Parts of the weights are usually determined through supervised learning, while the others are obtained through unsupervised learning.

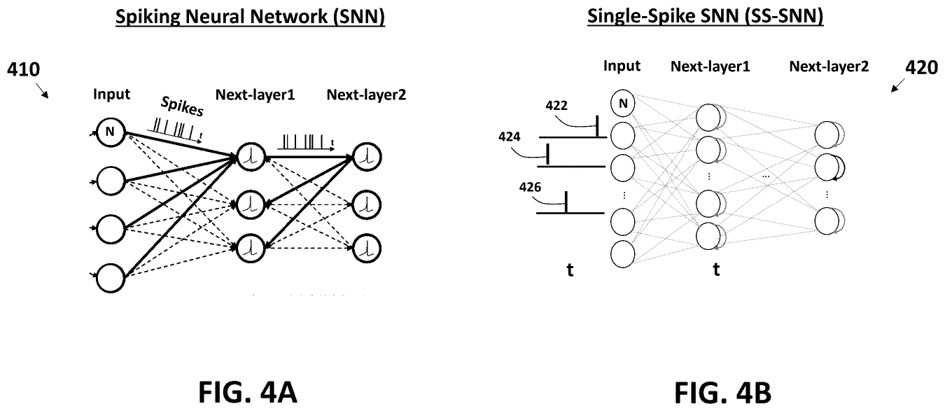

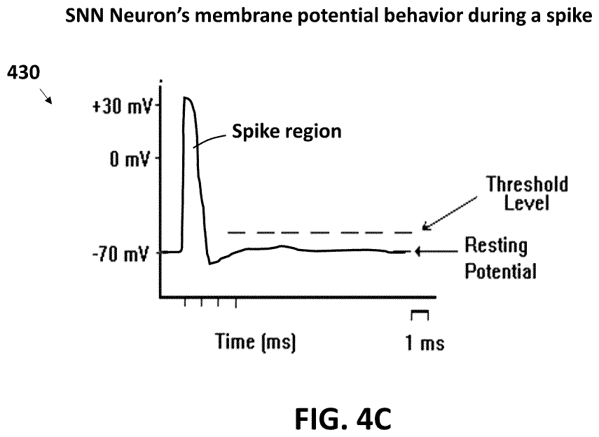

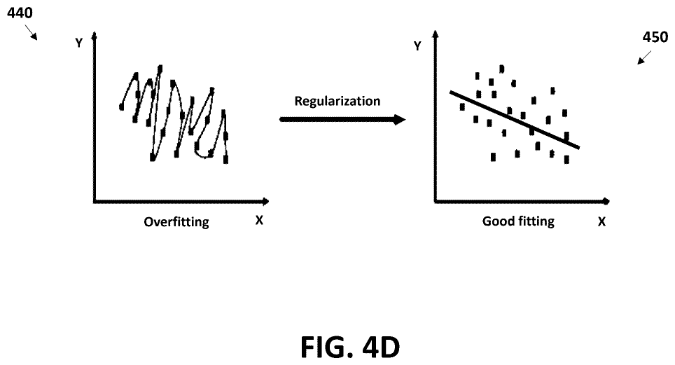

FIG. 4A depicts a simplified block diagram illustrating a general architecture of spiking neural network (SNN) 410 operable to be utilized in implementing aspects of the invention. As shown, the SNN 410 includes a network of artificial neurons or nodes (one of which is labeled N in FIG. 4A) organized as Input layer(s), Next-layer1, and Next-layer2. In some instances, Next-layer1 and Next-layer2 can both be hidden layer(s). In some instances, Next-layer1 and Next-layer2 can be hidden layer(s) and output layer(s). Despite being similar to one another, artificial neurons do not actually mimic the behavior of biological neurons. Thus, biological and artificial NNs are fundamentally different in general structure, neural computations, and learning rules compared to the brain. In general, a difference between a traditional ANN and a traditional SNN is the information propagation approach. SNNs in general attempt to more closely mimic a biological neural network. For example, instead of communicating analog values used in standard ANNs, SNNs communicate binary values (spikes) at certain points in time.

SNN models are typically built using mathematical equations that describe the behavior of spiking neurons. These equations take into account various factors such as the input current, membrane potential, and membrane time constant, to simulate the behavior of biological neurons. Each SNN model has its own set of equations that determine its behavior, and several standard model types have been developed, including, for example, leaky integrate-and-fire (LIF), non-leaky integrate-and-fire (NLIF), adaptive exponential integrate-and-fire (AdEx), and the like. Each of these SNN models is implemented using the update method, which takes an input current and a time step and returns whether a spike has occurred or not. The update method uses the equations that describe the behavior of the spiking neurons to calculate the membrane potential of each neuron at each time step. If the membrane potential exceeds a certain threshold, a spike is generated and propagated to the next neurons.

FIG. 4C depicts an example of a SNN neuron's membrane potential behavior during a spike. As shown, SNNs receive a series of spikes as input and produce a series of spikes as the output. A series of spikes is usually referred to as a spike train. The general concept of a “spike” is depicted by the graph 430 shown in FIG. 4C and described as follows. At every moment of time each SNN neuron has some value that is analogous to the electrical potential of biological neurons; the value in an SNN neuron can change based on the mathematical model of the SNN neuron, for example, if the SNN neuron receives a spike from the upstream SNN neuron, the value might increase or decrease; if the value in an SNN neuron exceeds some threshold, the SNN neuron will send a single impulse (shown in FIG. 4C as the “Spike region”) to each downstream SNN neuron connected to the initial one; and, after this, the value of the SNN neuron will instantly drop below its average. Thus, the SNN neuron will experience the analog of a biological neuron's refractory period. Over time, the value of the SNN neuron will smoothly return to its average (or resting potential). The moment of threshold crossing defines the firing time t(f). The SNN model shown in FIG. 4C makes use of the fact that spikes of a given neuron always have roughly the same form. If the shape of a spike is always the same, then the shape cannot be used to transmit information. Instead, information is contained in the presence or absence of a spike. Therefore spikes are reduced to “events” that happen at a precise moment in time. Neuron models where action potentials are described as events are called “integrate-and-fire” (IF) models. IF models have two separate components that are both necessary to define their dynamics—first, an equation that describes the evolution of the membrane potential v(t); and second, a mechanism to generate spikes.

FIG. 4B depicts a simplified block diagram illustrating a general architecture of a single-spike neural network (SS-SNN) 420 operable to be utilized in implementing aspects of the invention. In general, neural encoding is the study of how neurons represent information by electrical signals (action potentials) at the level of individual cells or in networks of neurons. Network performance is improved by using relatively fast information encoding methods, which enable very fast information processing by the network. At least in some NN systems, the efficient processing of information is more likely to be based on the precise timing of action potential (temporal coding). Single-spike temporal coding denotes that each neuron spikes at most once, and more salient information is encoded with earlier spikes (e.g., single-spikes 424, 426 shown in FIG. 4B) over later spikes (e.g., single-spike 422 shown in FIG. 4B).

Thus, SNNs (e.g., SNN 410 shown in FIG. 4A and/or SS-SNN 420 shown in FIG. 4B) represent special classes of NNs, where neuron models communicate by sequences of spikes that align better with the principles of the brain's operation to better understand and implement concepts leading to sustainable AI. Because the technology for using and implementing ANNs is more developed than the technology for using and implementing SNNs, there exists a significant library of pre-trained ANNs that have strong performance records for multiple task types. However, there are technical benefits and effects of SNNs over ANNs, including, but not limited to the fact that SNNs, and particularly SS-SNNs, can be implemented in a manner that controls the number of spikes. Controlling and/or reducing the number of spikes also controls and/or reduces the computational demands at each SNN neuron, which generally improves the computational efficiency of SS-SNNs in comparison to conventional ANNs. Additionally technical benefits of SNNs include the fact that SNNs are dynamic, which allows them to excel at working with dynamic processes such as speech and dynamic image recognition; an SNN can still train when it is already working; SNNs usually have fewer neurons than the traditional ANNs; SNNs can, potentially, work very fast because the neuron models send impulses instead of a continuous value; and SNNs have increased productivity of information processing and noise immunity over ANNs because SNNs use the temporal presentation of information. The computational efficiency of SNNs, and particularly SS-SNNs, over ANNs enable SNNs to use local processor resources to perform tasks that would, if performed by an ANN, mandate larger processor resources that in many cases cannot be provided locally and are typically only available through accessing remote servers or cloud computing processor resources.

Although SNNs offer solutions to a broad range of specific problems in applied engineering, including, for example, classification problems, there are challenges in realizing the benefits of SNNs. For example, there is a lack of effective and well-established learning methods developed specifically for SNN training. The specifics of SNN operations do not allow data scientists to effectively use traditional learning methods, for example, gradient descent. There are unsupervised biological learning methods that can be used to train an SNN; however, such methods are time-consuming and do not match the speed and learning performance of traditional ANN learning techniques applied to ANNs. Additionally, when using SNNs for real-world applications, the SNN's overall performance will be impacted by two metrics, namely task accuracy (e.g., classification accuracy) and task latency (e.g., classification latency). In general, a model's task accuracy is the fraction of total predictions made by the model that are correct. The percentage of correct predictions for a model can be determined in a variety of ways. For example, the task accuracy for a prediction model can be computed as the total number of correct predictions divided by the total number of predictions. In general, a model's task latency is a measurement to determine the performance of a model for carrying out its task (e.g., a classification task). Latency refers to the time taken to process one unit of data provided only one unit of data is processed at a time. The unit of latency is seconds (time unit). In terms of image classification tasks, latency is the time taken to process one image for batch size one (1). Batch size is the number of images processed at a time together. For example, Model-A is trained for image classification and takes 0.057 seconds to classify one image. In comparison, Model-B is trained for image classification and takes 0.009 seconds to classify the same image. Thus, stated more generally, latency is the time a user has to wait to receive the task result. If the waiting time is observable, it provides a poor user experience. It is generally a desired performance features for NN systems to work in real time and hence, it is important to improve latency. In general, known SNN-based systems do not provide adequate control and or management of an SNN-based (and/or SS-SNN-based) system's task accuracy and task latency.

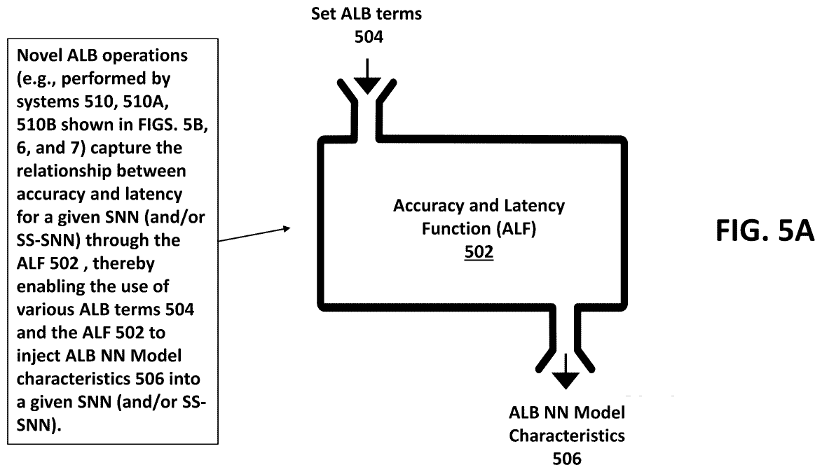

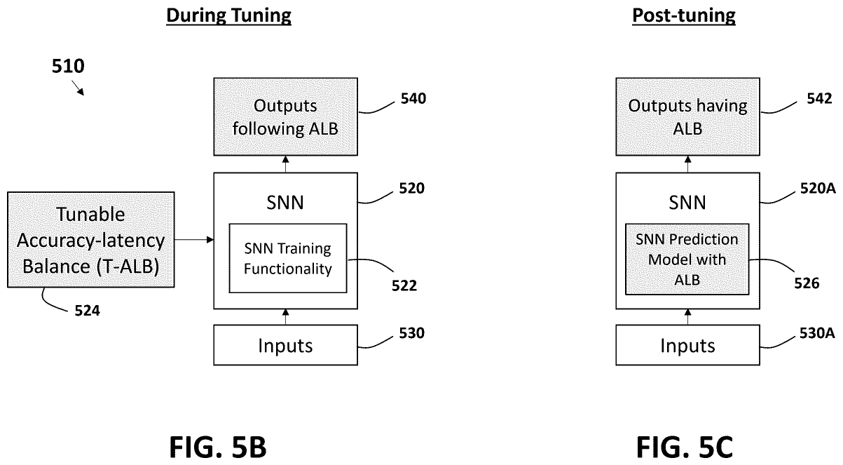

Embodiments of the invention described herein provide SNN-based (and/or SS-SNN-based) systems (e.g., systems 510, 510A, 510B shown in FIGS. 5B, 6, and 7) operable to provide control and or management of the SNN-based (and/or SS-SNN-based) system's task accuracy and task latency. An example of controlling and/or managing the SNN-based (and/or SS-SNN-based) system's task accuracy and task latency is depicted by the diagram shown in FIG. 5A. As shown in FIG. 5A, in some embodiments of the invention, an SNN (and/or SS-SNN) is created in a manner that incorporates novel accuracy-latency balance (ALB) operations (e.g., performed by systems 510, 510A, 510B shown in FIGS. 5B, 6, and 7) in the SNN/SS-SNN creation process, thereby generating an SNN model (or SS-SNN model) having ALB NN model characteristics 506. In some embodiments of the invention, ALB NN model characteristics 506 are achieved by mapping a pre-trained ANN model to an SNN space without SNN training. In some embodiments of the invention, ALB NN model characteristics 506 are achieved during SNN training. In accordance with aspects of the invention, the novel ALB operations capture the relationship between accuracy and latency for a given SNN. In other words, the novel ALB operations influence a function (e.g., the accuracy and latency function (ALF) 502 shown in FIG. 5A) that governs the relationship between accuracy and latency for a given SNN, thereby enabling the novel ALB operations to set the accuracy and latency of the model in a manner that matches the model's task. For example, a task given to the model (e.g., image classification) can place a high priority on having low latency and place a lower priority on having high accuracy. The novel ALB operations utilize knowledge of the function that governs the relationship between accuracy and latency to control the accuracy and latency built into the model during model creation (or construction, or formation) such that a higher priority is placed on generating task outputs with low latency and a lower priority is placed on generating task outputs with high accuracy, thereby controlling the model creation/construction/formation operations in a manner that matches the model's accuracy and latency to the model's task. By capturing the relationship between accuracy and latency, the novel ALB operations provide a methodology to, in effect, tune the desired accuracy and latency into the model during its creation/construction/formation.

In some embodiments of the invention, the novel ALB operations include computing a loss term used in the SNN/SS-SNN training operation based at least in part on an ALB regularization loss term and a cross-entropy loss term. The computed loss term is referred to herein as a tuneable ALB term, which is used to adjust the model weights such that spike timing of the correct class occurs in an earlier time instance of the spike timing interval, thereby decreasing latency. The decreased latency leads to fewer input spikes being included in the calculations.

In some embodiments of the invention, the SNN-based (and/or SS-SNN-based) system operable to provide control and or management of the SNN-based (and/or SS-SNN-based) system's task accuracy and task latency take advantage of the relatively large library of trained well-functioning ANNs for a variety of tasks, and further take advantage of the previously-described advantages of relatively sparse and processor resource efficient SNNs and/or SS-SNNs, by identifying a suitable trained ANN for a given task and creating a corresponding SS-SNN for the given task. Embodiments of the invention create the corresponding SS-SNN by mapping the learning built into the trained ANN to the corresponding SS-SNN, thereby creating an SS-SNN operable to provide the same performance level on the given task as the ANN but without requiring the same processor resources required by the ANN. In some embodiments of the invention, the starting or map-source ANN is fully trained for the given task. In some embodiments of the invention, the map-source ANN is fully trained for a task that is different but close to the given task, such that the map-source ANN is actually a map-source1 ANN that acts as a foundation model from which the desired or map-source2 ANN model can be created. In general, foundation models are AI models designed to produce a wide and general variety of outputs. They are capable of a range of possible tasks and applications, such as text, image or audio generation. They can be standalone systems or can be used as a “base” for many other applications.

In some embodiments of the invention, the previously-described mapping is performed using a mapping functionality operable to incorporate a novel accuracy-latency balance operation. In some embodiments of the invention, the novel accuracy-latency balance operation includes computing time intervals used in the SNN/SS-SNN operation based at least in part on a tuneable ALB mapping term. The ALB mapping term is used to adjust the size of the time intervals such that the readout time of the correct class occurs in an earlier time instance, thereby decreasing latency. The decreased latency leads to fewer input spikes being included in the calculations.

In embodiments of the invention, the previously-described mapping is performed using a mapping functionality operable to, from a “source” ANN solution, obtain a “target” SNN solution that for equivalent input data produces equivalent output data. The mapping functionality performed in accordance with embodiments of the invention is referred to herein as approximation-free in that the target SNN solution has prediction performance that is substantially equivalent to the prediction performance of the source ANN solution.

In some embodiments of the invention, the previously-described mapping is performed using a mapping functionality operable to, from an ANN solution, obtain an SNN solution that for equivalent input data produces equivalent output data. In some embodiments of the invention, the mapping functionality is operable to, from an ANN solution with rectified linear units (ReLUs) and optional convolutions and optional batch normalizations, obtain an SNN solution with single-spike coding and piecewise linear neuronal dynamics with specific time intervals that for equivalent input data produces equivalent output data. In general, a ReLU is an activation function that introduces the property of non-linearity to a deep learning model and solves the vanishing gradients issue. The output of the activation function is also called activation. In some embodiments of the invention, the mapping functionality includes a two-step mapping, where the first mapping is from an original ANN architecture and parameters (i.e., ANN components) to an intermediate or scaled ANN architecture and parameters (i.e., scaled ANN components). The first mapping includes transformation of input and output coding and transformation of the network structure of the original ANN architecture and parameters to create the scaled ANN architecture and parameters, which are equivalent to the original ANN architecture and parameters. The second mapping converts the scaled ANN architecture and parameters to their equivalent form of an SNN architecture and parameters (i.e., SNN components), which is the SNN solution.

In some embodiments of the invention, the pre-trained ANN has equivalent performance to the converted SNN in that the SNN has been configured to include specific neuronal dynamics that depend from and are based on parameters of the pre-trained ANN. In other words, the specific calculations inside the SNN neurons (the neuronal dynamics) cannot be arbitrary, but are instead defined according to criteria that depend on parameters and/or architectural features of the pre-trained ANN. For example, the pre-trained ANN parameters can include weights and/or biases, which determine the strength of connections between neurons in the pre-trained ANN. These parameters from the pre-trained ANN can be used to compute the parameters of the converted SNN. Thus, embodiments of the invention achieve operational equivalency between the pre-trained ANN and the converted SNN by using the pre-trained ANN parameters to calculate all of the parameters that are necessary for the converted SNN to generate outputs. Accordingly, it can be mathematically proven that these two networks (the pre-trained ANN and the converted SNN) are equivalent, and the same outputs generated by one of the two networks can be generated by the other network. Thus, the SNN created using embodiments of the invention delivers performance that is substantially equivalent to the performance of the pre-trained ANN from which the converted SNN was derived, which enables ANN performance to be achieved with the computational efficiency of SNNs and without the computational expense of ANNs.

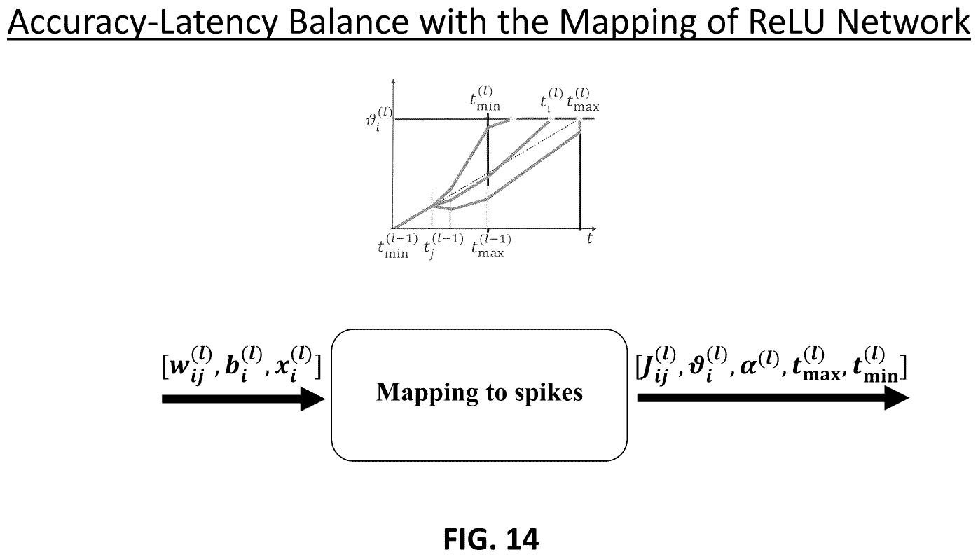

Some embodiments of the invention use preprocessing operations to normalize or scale the ANN parameters and architecture, and then use conversion operations to convert the scaled/normalized ANN architecture and parameters to the architecture and parameters that will be used in the converted SNN. In the preprocessing operations, the pre-trained ANN architecture includes a configuration of different layers, which can include, for example, fully connected layers, convolutional layers, max pooling layers, and the like. The preprocessing operations fuse certain of the pre-trained ANN layers to reduce the number of layers that need to be converted. However, because the resulting SNN will need to be equivalent to the pretrained ANN, layer fusion is applied only to layers in the pretrained ANN that can be fused while maintaining functional equivalence with the pre-fused layers. Additionally, the preprocessing operations further include scaling or normalizing the weights of the pretrained ANN. The weights in the pretrained ANN determine or define how strong the neuronal connections are, and in this portion of the preprocessing operations, the input weights and the output weights of each neuron are scaled or normalized, which provides uniformity to the subsequent conversion operations. Additionally, the preprocessing operations further include computing the maximum output (Xₙ) of each layer of the pretrained ANN so that this maximum layer output value can be used to set a maximum size of a spiking window provided in the converted SNN in accordance with aspects of the invention (shown in FIGS. 14, 15, and 16). In the conversion operations, the spiking interval of each SNN layer is configured and arranged to create a tₘₐₓ value that sets a maximum value of the spiking interval to make sure that the spiking interval is large enough to perform the operations converted to the SNN from the pretrained ANN.

The approximation-free mapping operations described herein can be applied to variety of types of source NNs and target NNs. For example, the source NN can include a variety of types of pre-trained analog-signal-based NNs; and the target NN can include a variety of types of temporal-coding-based NN. In some embodiments of the invention, the pre-trained analog-signal-based NNs include ANNs. In some embodiments of the invention, the temporal-coding-based NNs include a SS-NN. In some embodiments of the invention, the temporal-coding-based NNs include a SNN.

Turning now to more detailed descriptions and illustrations of embodiments of the invention, FIG. 5B depicts a simplified block diagram of a system 510 operable to tune an SNN 520 to include ALB in accordance with aspects of the invention. Tuning of the ALB terms (hyperparameters) involves selecting the best values to achieve the desired accuracy latency balance on the validation set. The validation set is used to monitor the performance of the model. In the evaluation step, the performance of the new model is evaluated on the test set. The test set is used to measure the generalization performance of the new model. If the new model performs well on the test set, it can be deployed in a production environment.

As shown in FIG. 5B, in accordance with embodiments of the invention, the inputs 530 are various forms of labeled or unlabeled training data, the SNN training functionality 522 is any suitable learning methodology for training the SNN 520, and the outputs 540 are the outputs generated by SNN 520 during tuning. In some embodiments of the invention, tunable ALB (T-ALB) operation(s) 524 are applied to the SNN training functionality 522 to provide control and or management of the accuracy and latency of the task the SNN 520 is being trained to perform. As shown, the training operation performed by the system 510 includes supplying inputs 530 to the SNN 520, and applying the SNN training functionality 522 to the inputs 530 to generate the outputs 540. In accordance with aspects of the invention, the T-ALB operations 524 capture the relationship between accuracy and latency for the SNN 520. In other words, the T-ALB operations 524 influence a function that governs the relationship between accuracy and latency for the SNN 520, thereby enabling the T-ALB operations 524 to set the accuracy and latency of the model of the SNN 520 in a manner that matches the accuracy/latency priorities of the task that will be performed by the SNN 520. For example, the task to be performed by the SNN 520 can place a high priority on having low latency and place a lower priority on having high accuracy. The T-ALB operations 524 utilize knowledge of the function that governs the relationship between accuracy and latency to control the accuracy and latency built into the model of the SNN 520 (e.g., SNN prediction model with ALB 526 shown in FIG. 5C) such that a higher priority is placed on generating the task outputs 540 with low latency and a lower priority is placed on generating the task outputs 540 with high accuracy, thereby controlling the model of the SNN 520 in a manner that matches the model's accuracy and latency to the model's task. By capturing the relationship between accuracy and latency, the T-ALB operations 524 provide a methodology to, in effect, tune the accuracy and latency built into the model of the SNN 520.

FIG. 5C depicts an SNN 520A, post-tuning, which is the SNN 520 (shown in FIG. 5B) after the tuning has been completed. The SNN 520A is obtained via performance of the tuning of FIG. 5B and includes an SNN prediction model with ALB 526 in accordance with embodiments of the invention. In response to inputs 530A, the SNN prediction model with ALB 526 generates outputs 542 having ALB that was built into the SNN prediction model with ALB 526 in accordance with aspects of the invention.

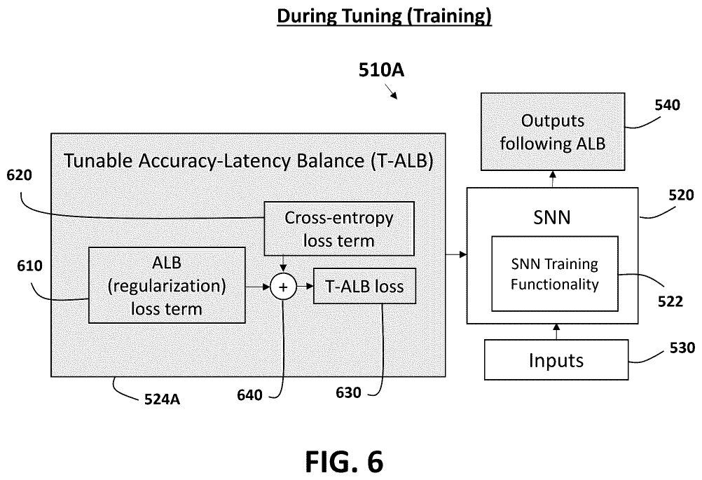

FIG. 6 depicts a simplified block diagram of a system 510A, which is a non-limiting example of how the system 510 (shown in FIG. 5B) can be implemented in accordance with some embodiments of the invention. The system 510A is substantially the same as the system 510 except the system 510A depicts additional detail of how the T-ALB operations 524 can be implemented as T-ALB operations 524A. The T-ALB operations 524A utilize a cross-entropy loss term 620 and an ALB/regularization loss term 610 passed through a summer 640 to generate a T-ALB loss 630. The T-ALB loss 630 is used during training of the SNN 520 to adjust the weights such that spike timing of the correct class occurs in an earlier time instance, thereby decreasing latency. The decreased latency leads to fewer input spikes being included in the calculations.

With respect to the cross-entropy loss term 620, cross-entropy loss is a metric used in machine learning to measure how well a classification model performs. The loss (or error) is measured as a number higher or equal to zero (0), with zero (0) being a perfect model. The goal is generally to bring the model as close to zero (0) as possible. Cross entropy loss measures the difference between the discovered probability distribution of a machine learning classification model and the predicted distribution. As an example, a loss function is used to help the model determine how “wrong” it is and, based on that “wrongness,” improve itself. In other words, the loss function is a measure of error, and the goal throughout model training is to minimize this error/loss. The role of a loss function is to appropriately penalize wrong outputs. If the model training operation does not penalize wrong output appropriately to its magnitude, it can delay convergence and affect learning.

With respect to the ALB/regularization loss term 610, in general, regularization loss is an additional loss generated by the regularization function. Regularization refers to techniques that are used to calibrate machine learning models in order to prevent overfitting. In conventional use, the regularization function includes methods used to help an optimization method to generalize better. An example of such a use of regularization is shown in FIG. 4D, which shows an overfitted plot 440 and a “good fitting” plot 450. The regularization parameter is a hyperparameter which determines the amount of regularization during training. In NNs, a model is defined or represented by the model parameters, which are the values the learning algorithm can change independently as it learns, and these values are affected by the choice of hyperparameters. Conventionally, the hyperparameters are set before training begins, and the learning algorithm uses them to learn the parameters. Although the learning algorithm use the hyperparameters when the learning algorithm is learning, the hyperparameters are not part of the resulting model. At the end of the learning process, the trained model parameters are effectively what is referred to as the model. In this regard, hyperparameters can be considered “external” to the model because the model cannot change hyperparameter values during learning/training. Thus, the process of training a model involves choosing the hyperparameters that the learning algorithm will use to learn the parameters that correctly map the input features (independent variables) to the labels or targets (dependent variable) such that the model achieves some form of intelligence. Embodiments of the invention do not focus on using regularization to achieve conventional goals such as preventing overfitting. Instead, some embodiments of the invention use regularization in a novel way to create the ALB/regularization loss term 610 and use it to enable the T-ALB operations 524A to achieve the goal of setting a desired ALB in the SNN training functionality 522 of the SNN 520.

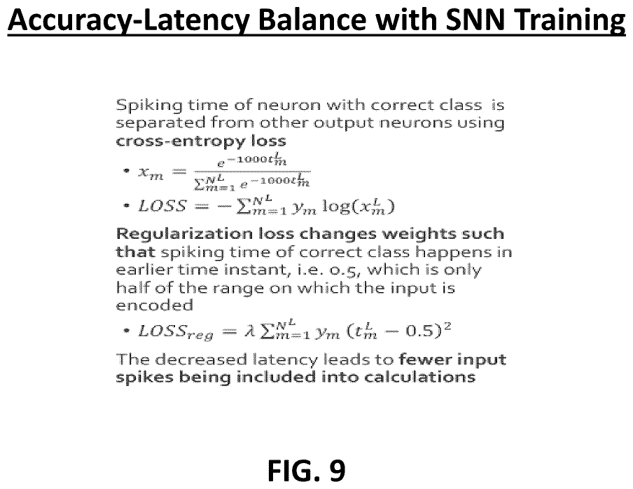

FIG. 9 depicts equations and computation processes or guidelines operable to determine the cross-entropy loss term 620 and the ALB/regularization loss term 610 in accordance with aspects of the invention. As shown, the spike timing of neurons with the correct class is separated from the other output neurons using the cross-entropy loss term 620, which can be computed using the top two equations shown in FIG. 9. It should be noted that in the first equation (moving from top to bottom) of FIG. 9, the value one-thousand (1000) can change depending on the application. Accordingly, the value one-thousand (1000) can be more generically represented as a variable (e.g., the variable β). The ALB/regularization loss term 610 changes weights such that spike timing of a correct class happens in earlier time instants. For example, where the input spike timing interval is normalized to a [0, 1] spike timing interval, the weights could be set such that spike timing of a correct class lies around a first half of the normalized input spike timing interval. For example, as shown in FIG. 9, the introduced shift hyperparameter set to 0.5 incentivizes the model to emit output spikes around time instance 0.5, halving in such case the time the usual [0, 1] normalized input spike interval is observed. The parameter lambda (λ shown in FIG. 9) is called the regularization parameter, which denotes the degree of regularization. Setting lambda to zero (0) results in no regularization, while large values of lambda correspond to more regularization. Using the techniques depicted in FIG. 9, decreased latency results in fewer input spike being included in the calculation performed by the SNN 520 (shown in FIG. 6). It is noted that the specific details of the equations shown in FIG. 9 and how to execute them would be understood by a person of ordinary skill in the relevant arts based on the present detailed description and the contents of FIG. 9.

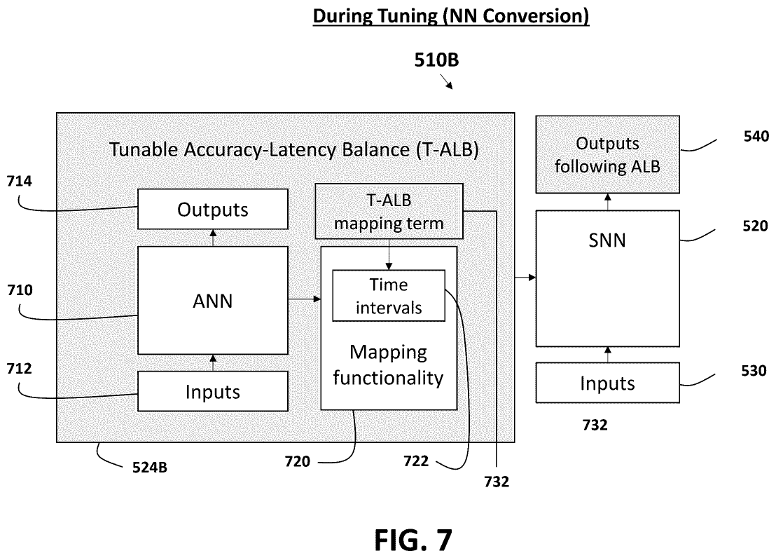

FIG. 7 depicts a simplified block diagram of a system 510B, which is a non-limiting example of how the system 510 (shown in FIG. 5B) can be implemented in accordance with some embodiments of the invention. The system 510B is substantially the same as the system 510 except the system 510B depicts additional detail of how the T-ALB operations 524 can be implemented as T-ALB operations 524B. The T-ALB operations 524B utilize an ANN 710 trained to perform a desired prediction task (using inputs 712 to generate prediction outputs 714) and uses a mapping functionality 720 to map or convert the trained ANN to a model of an SNN 520. The mapping functionality 720 performs its mapping functionality operations using a T-ALB mapping term 732 and time intervals 722 in accordance with aspects of the invention.

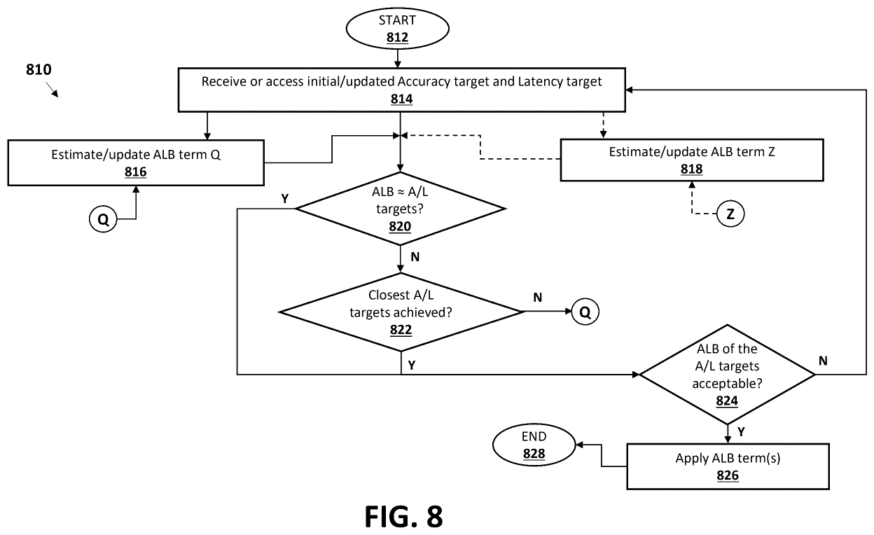

FIG. 8 depicts additional details of how aspects of the systems 510, 510A, 510B (shown in FIGS. 5B, 6, and 7) can be implemented in accordance with some embodiments of the invention. More specifically, FIG. 8 depicts a computer-implemented methodology 810 for optimizing ALB through setting selected ALB-related components (e.g., T-ALB loss 630 shown in FIG. 6; and/or T-ALB mapping term 732 shown in FIG. 7) of the T-ALB operations 524, 524A, 524B (shown in FIGS. 5B, 6, and 7). In some embodiments of the invention, the methodology 810 can be implemented using the computing environment 100 programmed to perform the methodology 810. In some embodiments of the invention, the methodology 810 can be integrated with the T-ALB operations 524, 524A, 524B and implemented using the computing environment 100 programmed to perform the operations of the T-ALB operations 524, 524A, 524B.

The methodology 810 begins at block 812 then moves to block 814 where the system 510, 510A, 510B accesses an initial or updated “Accuracy target,” along with an initial or updated “Latency target.” In some embodiments of the invention, the Accuracy target can be measured as a percentage of outputs 540, 542 that are accurate; and the Latency target can be measured in the time it takes to, in a response to an instance of the input 530, 530A, generate a corresponding instance of the output 540, 542. In some embodiments of the invention, the Accuracy target and the Latency target are selected by a user and provided to the system 510, 510A, 510B using any suitable means (e.g., UI device set 123 shown in FIG. 1). In accordance with aspects of the invention, the Accuracy target and the Latency target reflect a desired accuracy and latency for a given application run on a given SNN. Rather than optimizing SNN creation/formation operations for output accuracy alone, embodiments of the invention allow a user (or designer) to optimize both the Accuracy target and the Latency target during creation or formation of the SNN 520, 520A (shown in FIGS. 5B and 5C) based on design priorities. In some applications, accuracy is a more important design priority than latency; in other applications, latency is a more important design priority than accuracy; and in other applications, latency and accuracy have substantially the same design priority.

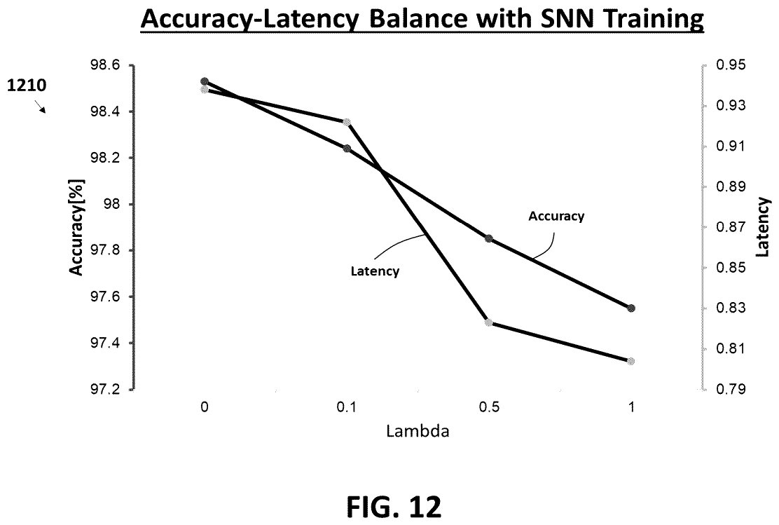

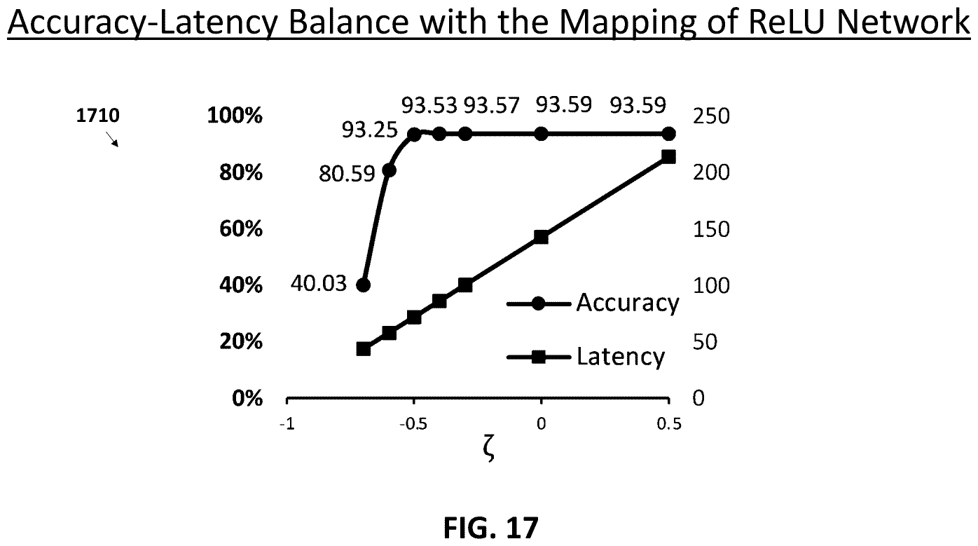

Based on the Accuracy target and the Latency target received at block 814, the methodology 810 moves to block 816 and/or block 818 and estimates or predicts values for ALB terms (shown in FIG. 8 as ALB term Q and ALB term Z) that can cause or influence the systems 510, 510A, 510B to optimize the accuracy and the latency of the outputs 540, 542 in an attempt to reach both the Accuracy target and the Latency target received at block 814. The designation “ALB term” is used herein to denote a term (e.g., the ALB/regularization loss term 610 shown in FIG. 6; the cross-entropy loss term 620 shown in FIG. 6; and/or the T-ALB mapping term 732 shown in FIG. 7) that can be set in a manner that causes or influences the system 510, 510A, 510B to optimize or set a desired balance between accuracy and latency in the outputs 542, 540. In embodiments of the invention where the methodology 810 is applied to the system 510A (show in FIG. 6), the ALB term Q can be the ALB/regularization loss term 610 shown in FIG. 6, and the ALB term Z can be the cross-entropy loss term 620 shown in FIG. 6. In embodiments of the invention where the methodology 810 is applied to the system 510B (show in FIG. 7), the ALB term Q can be the T-ALB mapping term 732 shown in FIG. 7, and the ALB term Z can be omitted (as indicated by the dotted line directional arrows into and out of block 818. In embodiments of the invention, the estimates determined at blocks 816, 818 can be performed in any suitable manner. In some embodiments of the invention, computer-based simulation algorithms can be used to estimate, through simulation, estimates of an ALB term Q and/or an ALB term Z that would satisfy (or nearly satisfy) the initial Accuracy target and the initial Latency target. In some embodiments of the invention, various plots or graphs (e.g., graph 1210 shown in FIG. 12 and/or graph 1710 shown in FIG. 17) can be generated and stored electronically for each system 510A, 510B, and any suitable graph analysis algorithm can be used to extract from the electronically stored graphs estimates of an ALB term Q and/or an ALB term Z that would satisfy (or nearly satisfy) the initial Accuracy target and the initial Latency target. The outputs from block 816 and/or block 818 are provided to decision block 820.

At decision block 820, the methodology 810 evaluates the ALB that results from the estimated ALB term Q and/or the estimated ALB term Z to determine whether the resulting ALB substantially matches (≈) the initial Accuracy target and/or the initial Latency target. The analysis at decision block 820 can be performed using substantially the computer simulation and/or electronic graph analysis functionality used at blocks 816, 818. If the answer to the inquiry at decision block 820 is no, the methodology 810 moves to decision block 822 to assess whether or not the current estimates for the ALB term Q and/or the ALB term Z (generated at blocks 816, 818) will provide actual accuracy and latency for the outputs 540, 542 that are as close as possible to the Accuracy target and the Latency target. In other words, the evaluation at decision block 822 is an assessment of whether the current estimates at blocks 816 and 818 and the estimated actual accuracy and latency for the outputs 540, 542 are the best optimization that can be achieved for the initial Accuracy target and the initial Latency target. If the answer to the inquiry at decision block 822 is no, the methodology 810 moves through Path Q (and/or alternatively through Path Z) to block 816 (and/or to block 818), generates updated estimates of the ALB term Q and/or the ALB term Z, and moves to decision block 820 to evaluate the updated estimates of the ALB term Q and/or the ALB term Z.

If the answer the inquiry at decision block 820 is yes, or if the answer the inquiry at decision block 822 is yes, the methodology 810 moves to decision block 824 to determine whether or not the ALB of Accuracy target and the Latency target are acceptable. The inquiry at decision block 824 can be presented to the user using any suitable tool such as the UI device set 123 shown in FIG. 1, and the user can provide a response to the inquiry at decision block 824 using the same tool. If the answer to the inquiry at decision block 824 is yes, the methodology 810 moves to block 826 and outputs the current version of the ALB terms Q and/or Z (initial or updated) to the system 510A, 510B. If the answer to the inquiry at decision block 824 is no, the methodology 810 returns to block 814 where the methodology 810 prompts the user to provide a new Accuracy target and Latency target, and additional iterations of the methodology 810 are performed for the new Accuracy target and Latency target.

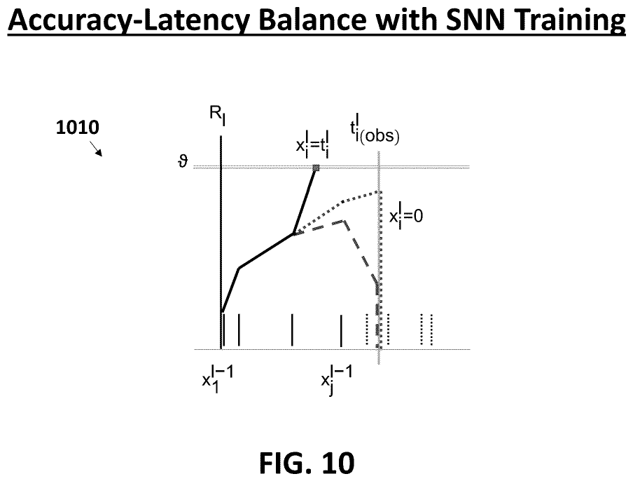

FIGS. 10, 11, 12, and 13 depict additional details of how various aspects of the system 510A (shown in FIGS. 5B and 5C) can be implemented in accordance with some embodiments of the invention. More specifically, FIG. 10 depicts a plot 1010 that depicts how aspects of ALB training operations performed by the T-ALB 524 operations (shown in FIG. 5B) can be implemented in accordance with aspects of the invention. The plot 1010 shows the integrate-and-fire (IF) neuronal dynamics of a spiking neuron. The observed neuron receives spikes from the previous layer and changes its membrane potential. Once the membrane potential reaches the threshold, the spike is generated and sent to the neurons in the next layer. If the neuron hasn't generated a spike before the end of the observable interval t_{i(obs)}, it will not spike at all in the current observable interval and a reset occurs for the start of a new interval.

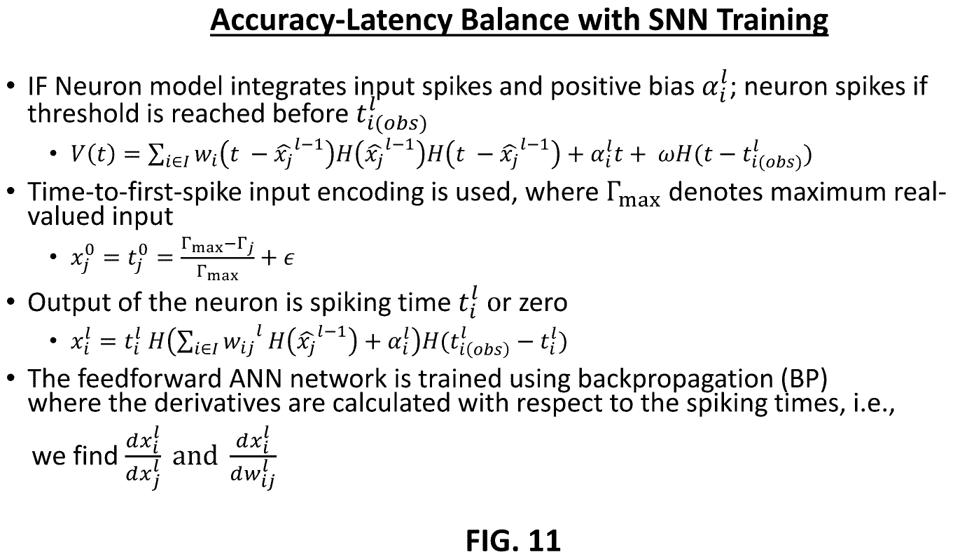

FIG. 11 depicts equations and computation processes or guidelines operable to perform operations of the T-ALB operations 524 (shown in FIG. 5B) in accordance with aspects of the invention. FIG. 11 shows formulas of how membrane potential evolves over time. Moreover, FIG. 11 explains how the spiking neural network can be trained using the backpropagation algorithm to enforce the T-ALB operations 524.

FIG. 12 depicts a graph (or plot) 1210 that illustrates performance results for an SNN with eight hundred (800) hidden neurons and ALB in accordance with aspects of the invention. The graph 1210 shows the graph depicting the trade-off between the Accuracy and Latency metrics. Hence, the ALB terms need to be tuned to reach the balance between the two metrics and satisfy as close as possible the Accuracy target as well as the Latency target.

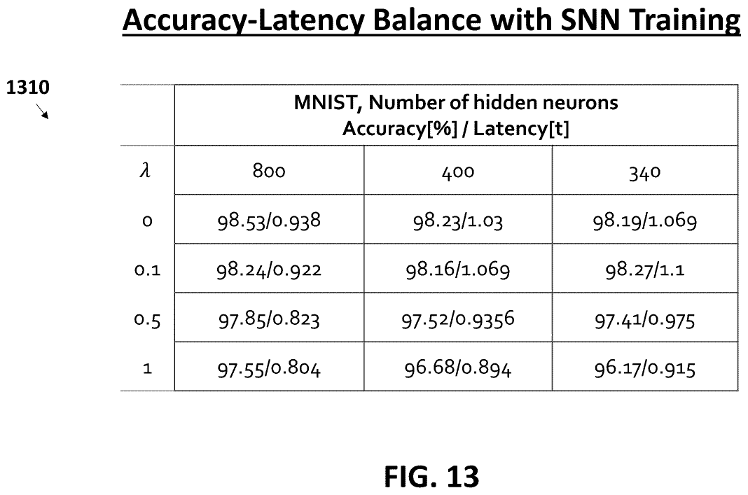

FIG. 13 depicts a table 1310 that illustrates performance results for an SNN with ALB in accordance with aspects of the invention. The table 1310 shows the trade-off between the Accuracy and Latency metrics for different numbers of neurons in the hidden layer (800, 400 and 340). Therefore, this drawing illustrates how additional factors can affect the technique that the ALB terms need to be tuned to reach the balance between the two metrics and satisfy as close as possible the Accuracy target as well as the Latency target.

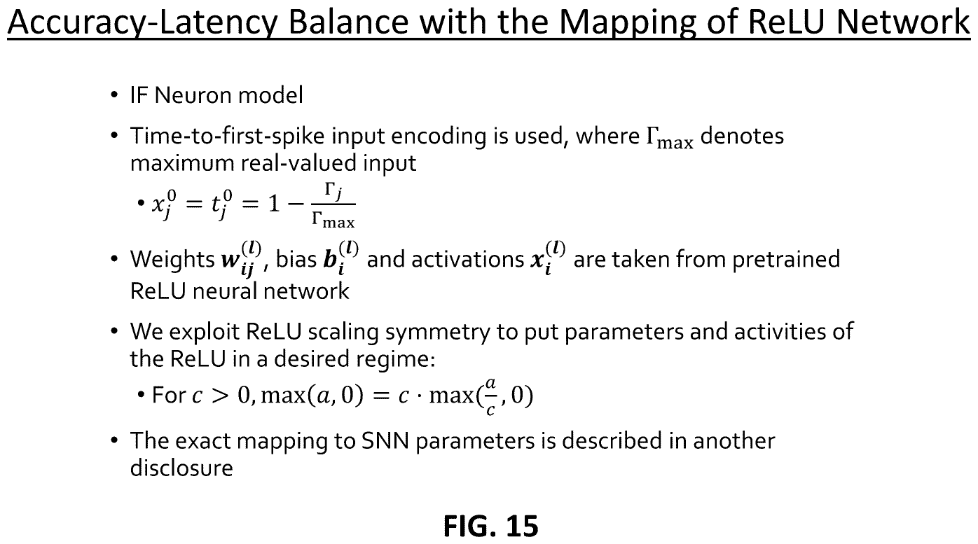

FIGS. 14 and 15 provide details on the mapping functionality 720 (shown in FIG. 7) and the time intervals 722 (shown in FIG. 7). The idea is that the mapping functionality 720 receives weights, bias and activations from the ANN 710 and outputs parameters of the SNN 520 such that there is no performance loss. During mapping, the ReLU scaling symmetry is exploited in order to put parameters and activities of the ReLU in a desired regime. Moreover, the mapping introduces time intervals 722 for each hidden layer, such that all neurons in certain layers are guaranteed to spike within their corresponding time interval. FIG. 15 shows some of the details of a non-limiting example of how the mapping functionality described herein can be implemented in accordance with aspects of the invention.

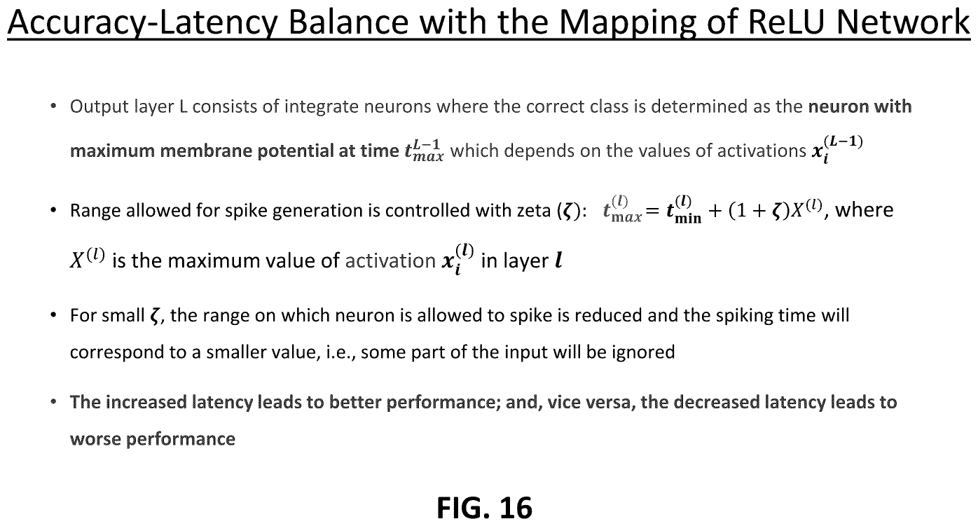

FIG. 16 provides details on the T-ALB mapping term 732. During mapping, the time intervals 722 are determined such that they depend on a hyperparameter 7. The time intervals 722 during which neurons are allowed to spike are reduced by modifying the value of the hyperparameter. This leads to a decreased classification latency. However, smaller time intervals can cause some part of the input information to be ignored, which leads to reduced performance. Embodiments of the invention enable a system designer to strike a desired balance between accuracy and latency to achieve ALB characteristic in the SNN model and ALB in outputs generated by the SNN model.

FIG. 17 depicts a plot 1710 that illustrates performance results for an SNN that results from the system 510B (shown in FIG. 7) in accordance with aspects of the invention. The plot 1710 shows the graph depicting the trade-off between the Accuracy and Latency metrics. Hence, the ALB terms need to be tuned to reach the balance between the two metrics and satisfy as close as possible the Accuracy target as well as the Latency target.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the future, may make various improvements and enhancements which fall within the scope of the claims which follow.

What is claimed is:

1. A computer-implemented method comprising:
executing a spiking neural network (SNN) to perform an SNN task;
wherein the SNN comprises accuracy-latency balance (ALB) characteristics that enable the SNN to perform the SNN task in a manner that achieves a predetermined ALB of an output generated by the SNN.

2. The computer-implemented method of claim 1, wherein the ALB characteristics are based at least in part on an accuracy and latency function (ALF).

3. The computer-implemented method of claim 2, wherein the ALB characteristics are based at least in part on a set of ALB terms applied to the ALF.

4. The computer-implemented method of claim 3, wherein:
the set of ALB terms comprises a regularization loss term and a cross-entropy loss term; and
the ALF comprises a set of model training operations.

5. The computer-implemented method of claim 3, wherein:
the set of ALB terms comprises ALB mapping terms; and
the ALB mapping terms comprise a hyperparameter.

6. The computer-implemented method of claim 5, wherein the ALF comprises a set of model mapping operations applied to an artificial neural network (ANN) model to create the SNN. 7 The computer-implemented method of claim 1, wherein:
the SNN comprises a single-spike SNN (SS-SNN).

8. A computer system comprising a processors system electronically coupled to a memory, wherein the processor system is operable to perform processor system operations comprising:
executing a spiking neural network (SNN) to perform an SNN task; and
wherein the SNN comprises accuracy-latency balance (ALB) characteristics that enable the SNN to perform the SNN task in a manner that achieves a predetermined ALB of an output generated by the SNN.

9. The computer system of claim 8, wherein the ALB characteristics are based at least in part on an accuracy and latency function (ALF).

10. The computer system of claim 9, wherein the ALB characteristics are based at least in part on a set of ALB terms applied to the ALF.

11. The computer system of claim 10, wherein:
the set of ALB terms comprises a regularization loss term and a cross-entropy loss term; and
the ALF comprises a set of model training operations.

12. The computer system of claim 10, wherein:
the set of ALB terms comprises ALB mapping terms; and
the ALB mapping terms comprise a hyperparameter.

13. The computer system of claim 12, wherein the ALF comprises a set of model mapping operations applied to an artificial neural network (ANN) model to create the SNN. 14 The computer system of claim 8, wherein:
the SNN comprises a single-spike SNN (SS-SNN).

15. A computer program product comprising a computer readable program stored on a computer readable storage medium, wherein the computer readable program, when executed on a processor system, causes the processor system to perform processor system operations comprising:
executing a spiking neural network (SNN) to perform an SNN task; and
wherein the SNN comprises accuracy-latency balance (ALB) characteristics that enable the SNN to perform the SNN task in a manner that achieves a predetermined ALB of an output generated by the SNN.

16. The computer program product of claim 15, wherein the ALB characteristics are based at least in part on an accuracy and latency function (ALF).

17. The computer program product of claim 16, wherein the ALB characteristics are based at least in part on a set of ALB terms applied to the ALF.

18. The computer program product of claim 17, wherein:
the set of ALB terms comprises a regularization loss term and a cross-entropy loss term; and
the ALF comprises a set of model training operations.

19. The computer program product of claim 17, wherein:
the set of ALB terms comprises ALB mapping terms;
the ALB mapping terms comprise a hyperparameter; and
the ALF comprises a set of model mapping operations applied to an artificial neural network (ANN) model to create the SNN.

20. The computer program product of claim 15, wherein:
the SNN comprises a single-spike SNN (SS-SNN).
